(19) United States
(12) Patent Application Publication
(10) Pub. No.: US 2014/0032659 A1
(43) Pub. Date: Jan. 30, 2014

(54) FACILITATING COMMUNICATIONS BETWEEN USERS OF MULTIPLE SOCIAL NETWORKS

(71) Applicants: Richard Marini, San Francisco, CA (US); Nathan Smith, (US); Raymond Siu, (US); Zack Onisko, (US)

(72) Inventors: Richard Marini, San Francisco, CA (US); Nathan Smith, (US); Raymond Siu, (US); Zack Onisko, (US)

(73) Assignee: BranchOut, Inc.

(21) Appl. No.: 13/560,852

(22) Filed: Jul. 27, 2012

(51) Int. Cl. G06F 15/16

(52) U.S. Cl. 709/204

(57) ABSTRACT

A system and method facilitates communications between users of multiple social networks by combining social graphs from the social networks. During operation, a user requests the system to search for particular parameters. The system determines a set of matching user profiles and provides profile information and connection options for each of the matching user profiles. The profile information provided to the user varies depending on the degree of connection to the profile and the type of connection. Similarly, the system varies the connection options provided based on the degree of connection and the network membership of the profile. Available connection options may include sending a direct message, requesting an introduction, saving the profile for later viewing, and sending a limited message.

### BACKGROUND

Social networks have significantly increased in popularity in recent years. A typical social network, such as the network provided by Facebook, Inc. of Menlo Park, Calif., allows individual users to register and provide various information about themselves. Users can then link their profiles to other registered profiles to indicate a social connection, such as group affinity or friendship. Users may also share personal updates, photographs, videos, and other information with other users of the network. Shared information may be public or limited to a particular group of people, such as direct connections. Users can view this information using a web browser or dedicated application; in addition, many social networks provide application programming interfaces (APIs) that allow other companies to build new services based on information and connections in the social network. For example, many news sites include a button that users can select to share an article on a social network. Other web sites build specialized communities (e.g., for book recommendations) using social information in an underlying social network. Typically, each social network has a set of formal restrictions on how user data can be used, as well as informal social norms developed based on expectations of the users. There have been few attempts to integrate multiple social networks with different restrictions on use of user data.

### BRIEF DESCRIPTION OF THE DRAWINGS

FIG. 1 is a network diagram of a representative environment in which a connector system operates.

FIG. 2 illustrates an example of a typical social graph for a user in a social network.

FIG. 3 is a high-level block diagram showing an example of the architecture of a computer system, such as a server suitable for implementing the connector of FIG. 1.

FIGS. 4A-4H illustrate an exemplary user interface for interacting with the connector system.

FIGS. 5A and 5B together illustrate a combined social graph that combines multiple social networks into a single social graph.

FIG. 6 illustrates a logical block diagram of the connector system.

FIG. 7A is a flowchart of a process for registering a user with the connector system.

FIG. 7B is a flowchart of a process for linking user profiles through an enterprise profile.

FIG. 7C is a flowchart of a process for generating an enterprise social graph.

FIG. 8 is a flowchart of a process for searching for particular user profiles and providing the results to the originating user.

FIG. 9 is a flowchart of a process for determining connection options to be provided for individual user profiles.

### DETAILED DESCRIPTION

A system and method for facilitating communications between users of social networks is disclosed (hereinafter referred to as the “connector system” or the “system”). The system allows users to integrate social connections, e.g., across multiple social networks that allow different levels of access to user data. In one example described in detail below, the system connects a first social network intended for job searching or recruiting with a second social network intended to enable social connections between friends and acquaintances. Because of their different purposes, these social networks will generally allow different types of information sharing and interaction between users. In some implementations, the system manages its own social network and also connects to one or more external social networks.

In some embodiments, a new user initially registers with the system by providing personal information (e.g., name, geographic location) to create a new user profile. After joining, the user can create connections with other users in the first social network, such as the recruiting network. The user may also provide information to link the new user profile to a user profile in a second social network, which maintains its own set of connections among its users, such as the friends network. In other embodiments, the user is initially a member of the second social network. In this case, the user may create a profile in the first social network as an add-on to the second social network. The system can then automatically link the social networks when the user creates the profile in the first social network. The system uses the link to create a combined social network with different classes of connections based on which network provides the connection. In some embodiments, the system provides the user with different levels of information from user profiles depending on which social network provides the connection to the user profile. For example, user profiles in the first social network may provide more searchable public information than profiles in the second social network.

During operation, the user may use the system to identify other users or other connections within the combined network. For example, the user may determine a set of search parameters to use in searching for other user profiles among multiple social networks within the larger network. The parameters may include keywords, geographic location, type of connection, and time periods that the profiles were active. The system then searches the larger combined network for a set of user profiles that match the search parameters and provides the information to the user.

Note, the system can determine the information to provide to the user based on the type of connection between the user's profile and each matching user profile. For example, the system may provide different information depending on which network connects the two user profiles or how close a connection exists between the user profiles. Further, the system can provide a set of connection options to the user for each matching user profile. The connection options are selected based on the type of connection between the user's profile and the matching user profiles. For example, the system may allow the user to send a direct message or follow updates for a user profile that is directly connected, but only offer the option to request an introduction for a user profile that is not directly connected (such as through an intermediary who is known by both the user and the not-directly-connected person, where the intermediary bridges two different networks). More details are provided below.

The system may also provide enterprise functionality that links the social graphs for a team within an enterprise. Each user profile in the enterprise has its own social graph; however, each linked user profile can also see connections to other linked accounts as if the connections were part of the user's own account. In effect, this expands every team member's social graph to include connections belonging to every other team member. The system may also maintain the connections even if a team member leaves the enterprise. This allows for institutional memory, so the enterprise does not lose its connections when individual team members leave. In general, the enterprise link is one-way—that is, the system treats connections from all team members as if they were direct connections, but users outside the team only see their own direct connections.

In general, brief definitions of several terms used herein are preceded by the term being enclosed within double quotation marks. Such definitions, although brief, will help those skilled in the relevant art to more fully appreciate aspects of the invention based on the detailed description provided herein. Such definitions are further defined by the description of the invention as a whole (including the claims) and not simply by such definitions. As used herein, a “social graph” is a set of connections between users in a social network. Each user profile is the root profile of an individual social graph. As discussed below, the root profile is the starting point for a tree of social network connections from a particular user. The overall social network (i.e. “larger network”) is then formed by combining the individual social graphs for all of its users. An “originating user” is a user who makes use of a social network to carry out a particular activity, such as search. An “originating user profile” is the user profile of an originating user; the originating user profile is the root profile of the originating user's social graph.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

Various examples of the invention will now be described. The following description provides certain specific details for a thorough understanding and enabling description of these examples. One skilled in the relevant technology will understand, however, that the invention may be practiced without many of these details. Likewise, one skilled in the relevant technology will also understand that the invention may include many other obvious features not described in detail herein. Additionally, some well-known structures or functions may not be shown or described in detail below, to avoid unnecessarily obscuring the relevant descriptions of the various examples.

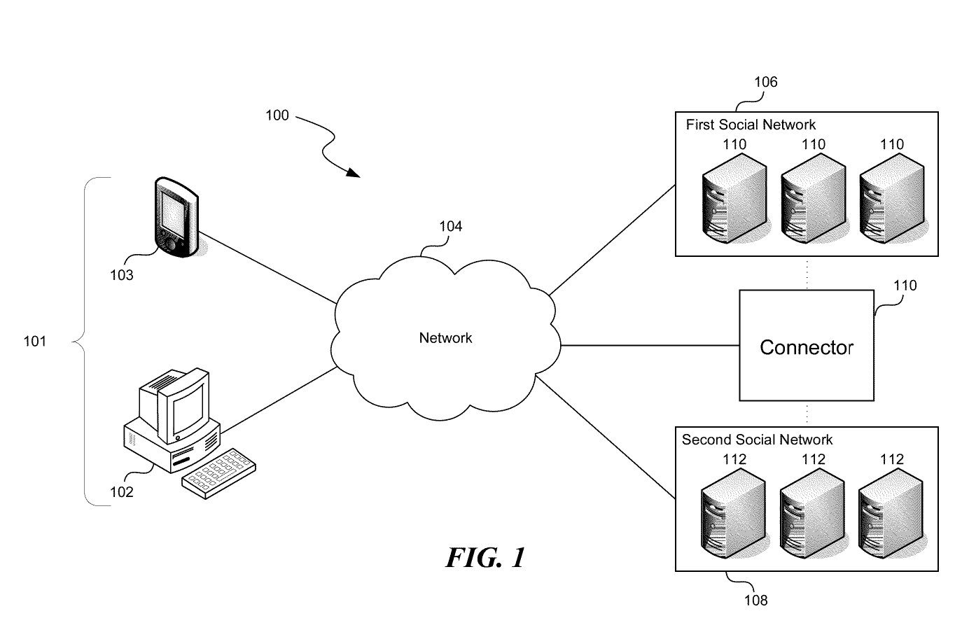

FIG. 1 and the following discussion provide a brief, general description of a suitable computing environment in which the invention can be implemented. Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones, tablets, etc.), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., flash or EEPROM semiconductor chips), nanotechnology memory, biological memory, or other data storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

FIG. 1 is a network diagram of a representative environment 100 in which the connector system operates. One or more client devices 101, such as a personal computer 102 and a smartphone 103, connect to a first social network 106 and a second social network 108 through a network 104, such as the Internet. The client devices 101 may also include other electronic devices suitable for connecting to a social network, such as PCs, laptops, netbooks, tablets, cellular phones, personal digital assistants (PDAs), game consoles, set top boxes, wearable computers, vehicle-mounted computers, embedded computers, and other connected devices. The first social network 106 includes one or more servers 110, which store and provide access to the first social network's data. Similarly, the second social network 108 includes one or more servers 112, which serve a similar purpose in the second social network 108. The servers 110 and 112 may be standard, commodity server systems or may include specialized hardware.

The environment 100 also includes a connector component 110, which integrates aspects of each of the social networks in order to provide services to the clients 101. The client devices 101 interact with the connector component 110 to use the integrated services provided by the connector system (described herein). The connector component 110 is logically connected to the social networks 106 and 108, as indicated by the dotted lines. In some cases, the social networks 106 and 108 are independent from the connector component 110; in these cases, the connector component 110 may communicate with both social networks through the network 104. In other cases, the connector component 110 maintains one of the social networks itself (referred to as an “internal social network”) and integrates with an independent social network (referred to as an “external social network”). In these cases, the connector component 110 may be directly linked to the internal social network without using the network 104.

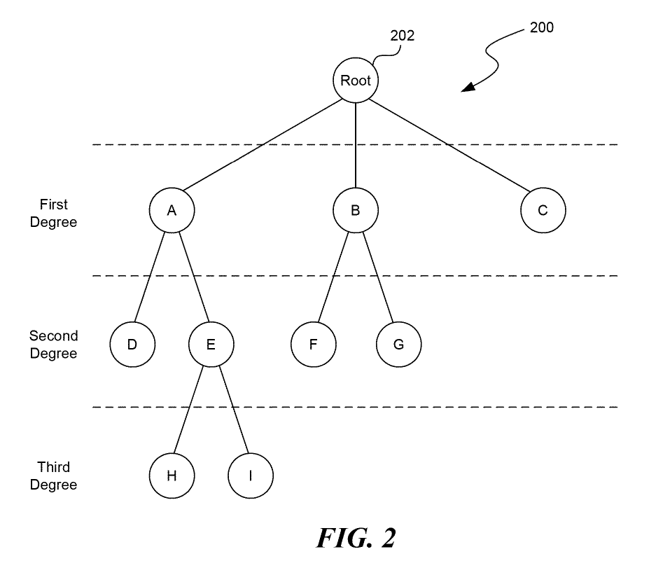

FIG. 2 is an example of a simple yet typical social graph 200 for a user in a social network. As shown in FIG. 2, the social graph 200 begins with a root profile 202, which corresponds to an individual user in the social network. The root profile 202 is directly connected to user profiles A, B, and C, who are referred to as first degree connections. Some networks (e.g., Facebook) refer to these first degree or direct connections as “friends”, while others simply refer to them as “contacts” or “connections”. In other words, the user associated with the root profile has three connections or “friends”, namely users A, B and C.

Each of the users A, B, and C has a profile, which is the root profile of its own social graph, with a similar set of connections. In particular, user profile A is directly connected to user profiles D and E in the social graph 200. User profiles D and E are first degree connections from user profile A and second degree connections from the root profile 202. Similarly, user profile B is directly connected to user profiles F and G, which are also second degree connections from the root profile 202. User profile E is connected to user profiles H and I, which are third degree connections from the root profile 202. Connections may be bi-directional, such that a connection from a first user profile to a second user profile implies a corresponding connection from the second user profile to the first user profile, or unidirectional, such that a connection in one direction does not imply a corresponding connection in the reverse direction.

User profiles in the social graph 200 are considered connected if one or more lines in the social graph can be used to trace a connection (assuming bi-directional connections). For example, the root profile 202 is considered connected to all of the profiles shown in FIG. 2 because a link can be traced from the root profile 202 to each user profile while only moving downward in the social graph 200. Similarly, user profile I is connected to the root profile 202 (assuming bi-directional connections) because a connection can be traced from user profile I to the root profile 202 while always moving upward in the social graph 200.

Social networks may choose to selectively display user information depending on the degree of the connection, such as showing a full user profile for a first degree connection but only showing a name for a second degree connection. In some cases, third or higher degree connections may be further anonymized such that the user only sees descriptive text, rather than name or other identifying information. Other methods of anonymizing are of course possible.

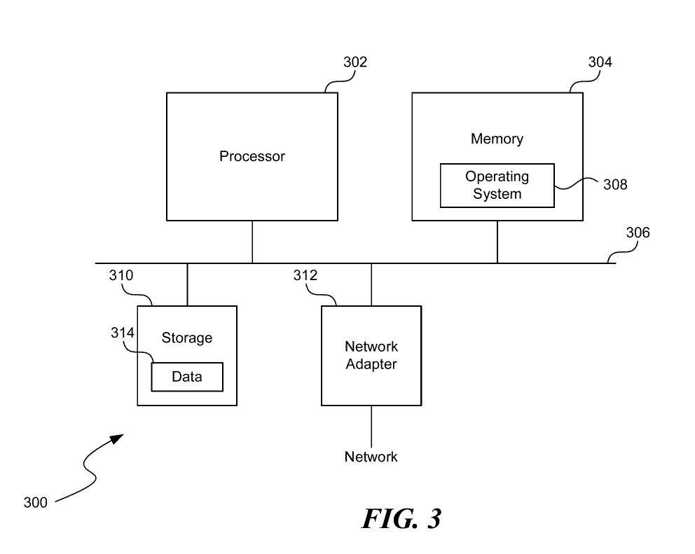

FIG. 3 is a high-level block diagram showing an example of the architecture of a computer system 300, such as a server suitable for implementing the connector component 110 of FIG. 1. The system 300 comprises one or more processors 302 and memory 304 coupled to an interconnect 306. The interconnect 306 shown in FIG. 3 is an abstraction that represents any one or more separate physical buses, one or more point-to-point connections, or both buses and point-to-point connections connected by appropriate bridges, adapters, or controllers. The interconnect 306, therefore, may comprise, for example, a system bus, a Peripheral Component Interconnect (PCI) family bus, a HyperTransport or industry standard architecture (ISA) bus, a small computer system interface (SCSI) bus, a universal serial bus (USB), a IIC (I2C) bus, an intrachip bus (e.g. for server-on-a-chip systems), or an Institute of Electrical and Electronics Engineers (IEEE) standard 1394 bus, sometimes referred to as “Firewire.”

The processor(s) 302 may comprise central processing units (CPUs) of the system 300 and, thus, control the overall operation of the system 300. In certain examples, the processor(s) 302 accomplish this by executing software or firmware stored in the memory 304. The processor(s) 302 may be, or may comprise, one or more programmable general purpose or special purpose microprocessors, digital signal processors (DSPs), programmable controllers, application-specific integrated circuits (ASICs), programmable logic devices (PLDs), or the like, or a combination of such devices.

The memory 304 is, or comprises, the main memory of the system 300. The memory 304 represents any form of fixed or removable random access memory (RAM), read-only memory (ROM), flash memory, or the like, or a combination of such devices. In use, the memory 304 stores, among other things, an operating system 308 of the device 300. The system 300 further comprises a network adapter 312 that provides the system 300 with the ability to communicate with client devices 101, as well as the first social network 106 and the second social network 108 (FIG. 1). The system 300 may further comprise local storage 310 coupled to the interconnect 306. The local storage 310 may comprise, for example, a flash memory device that is configured to provide mass storage and that stores data 314 used by the mobile device.

The memory may store the user profiles described herein. The user profiles may be formed of any known data structure. In one example the profiles form part of a user database, where the user database may again be formed of any know database scheme. Such database tracks connections between user profiles, thus defining social graphs.

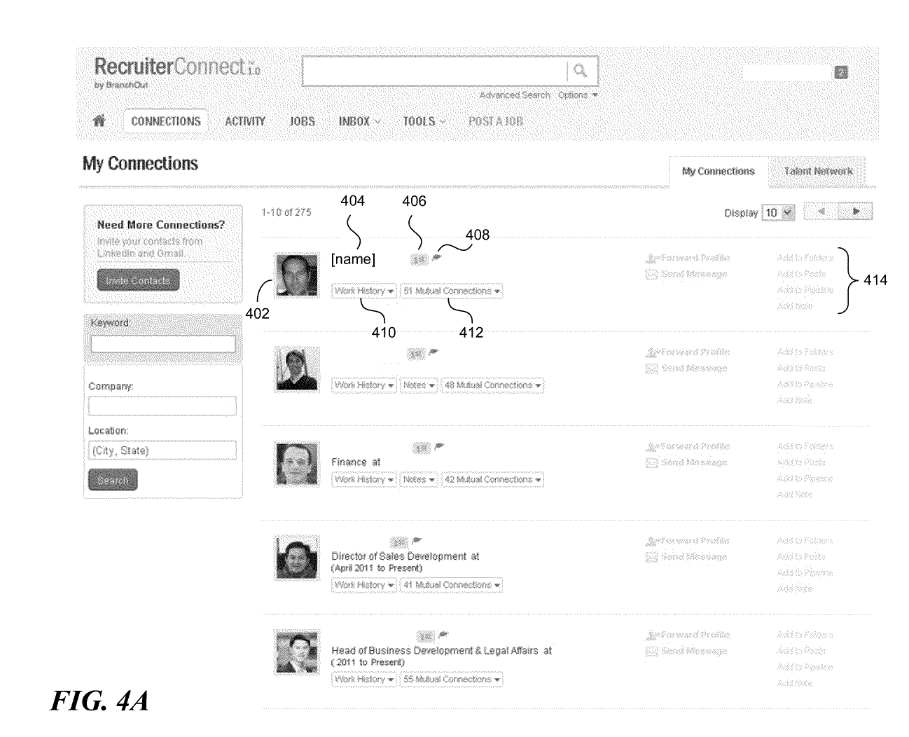

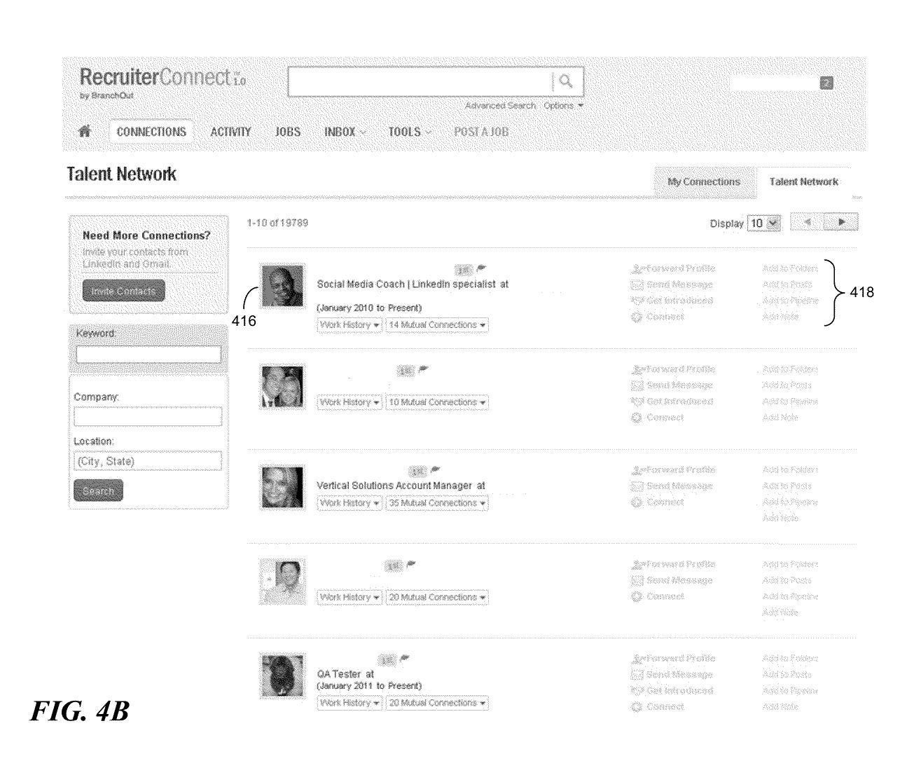

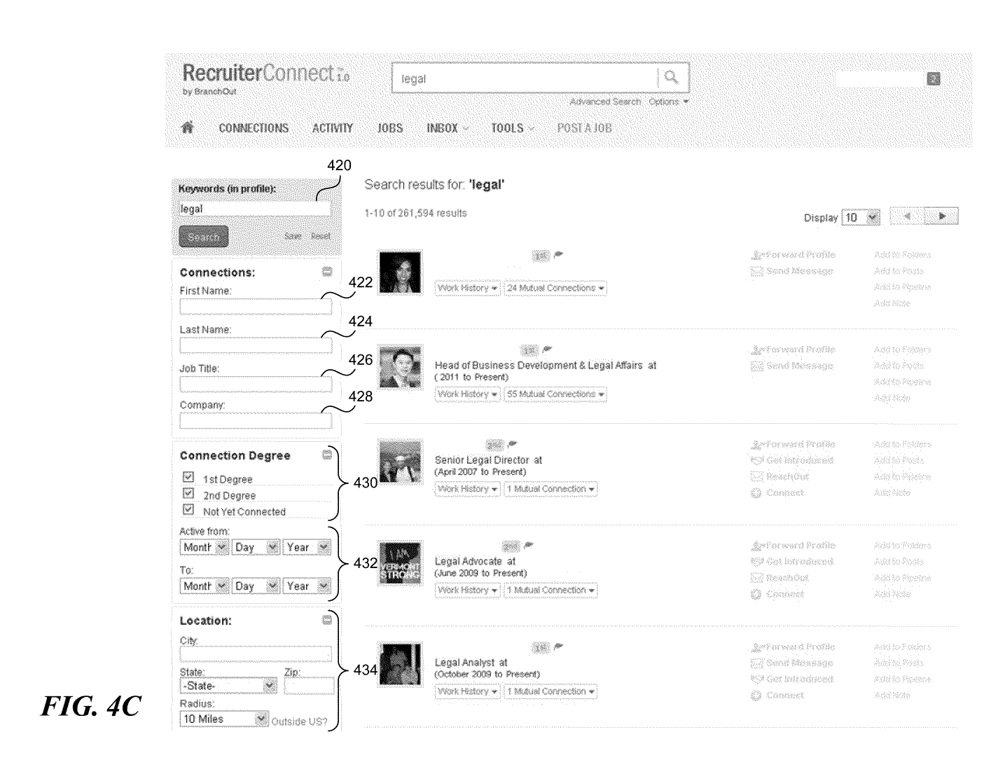

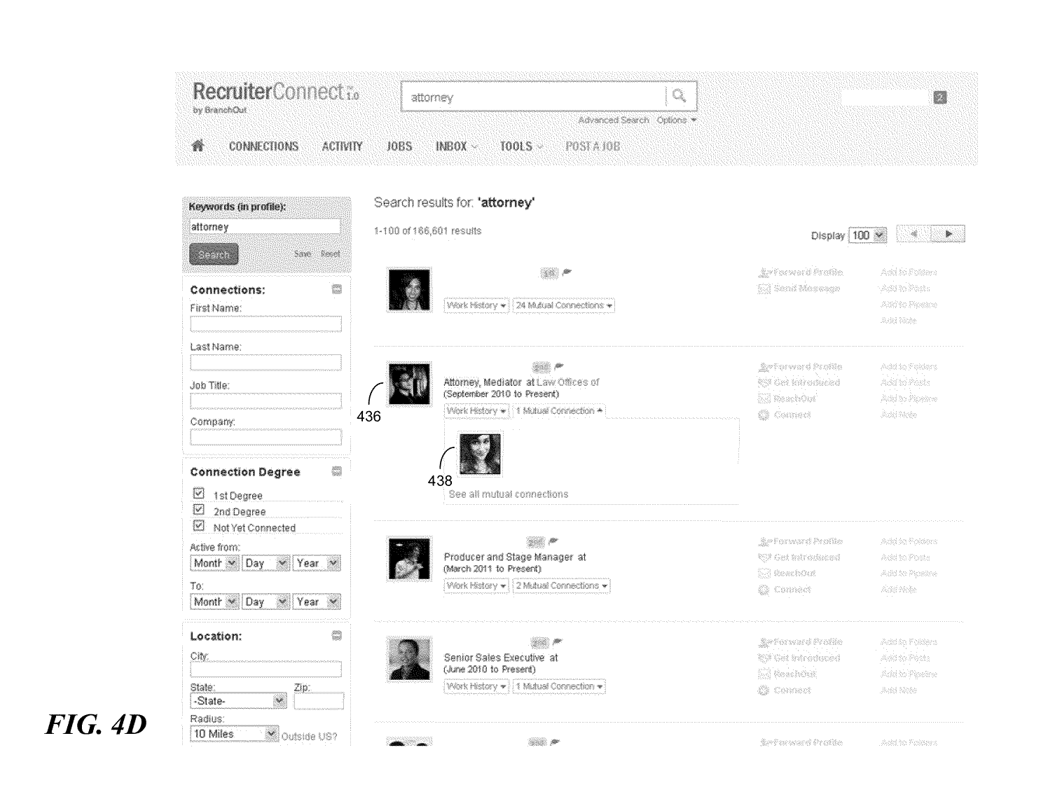

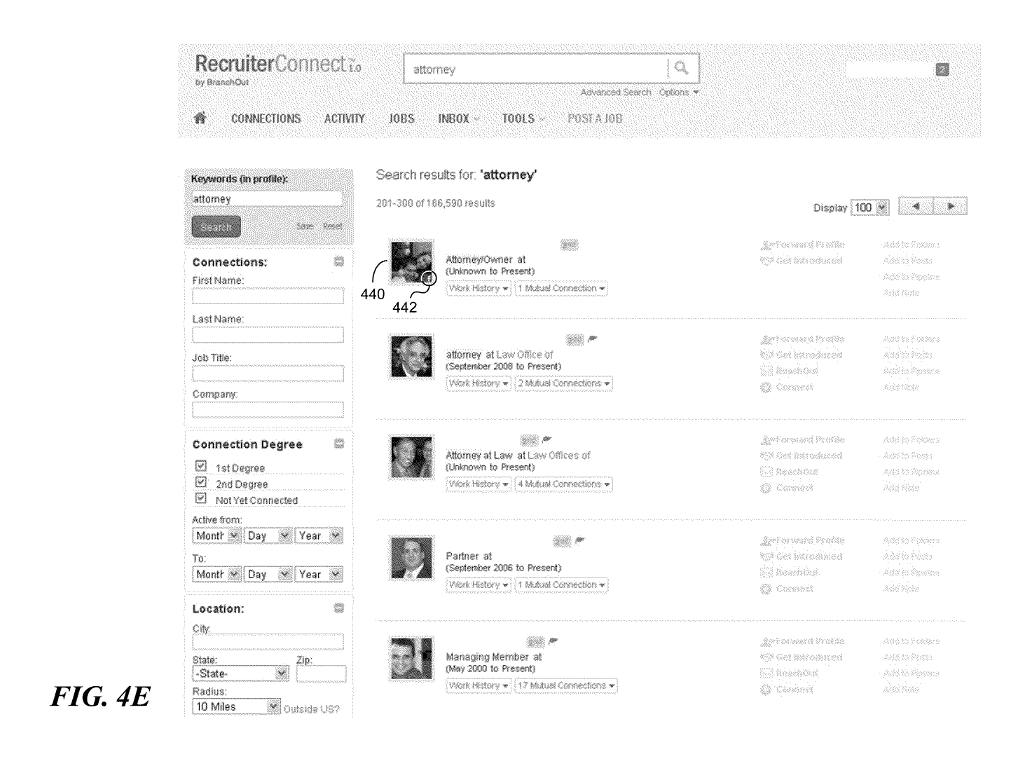

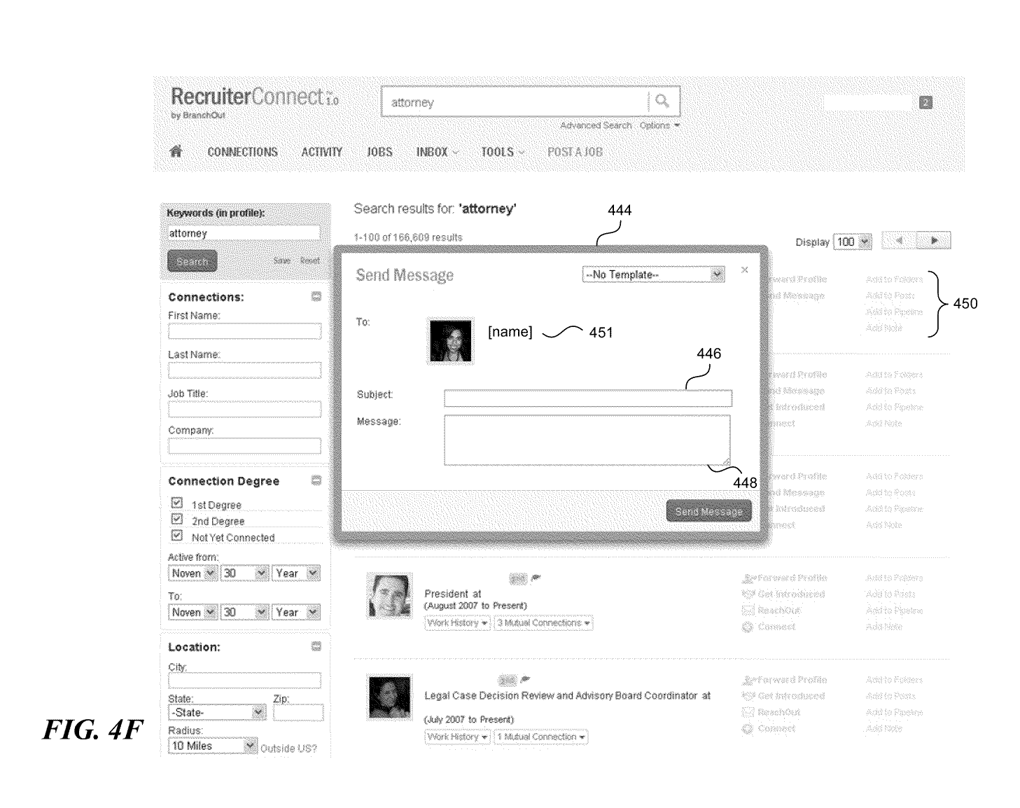

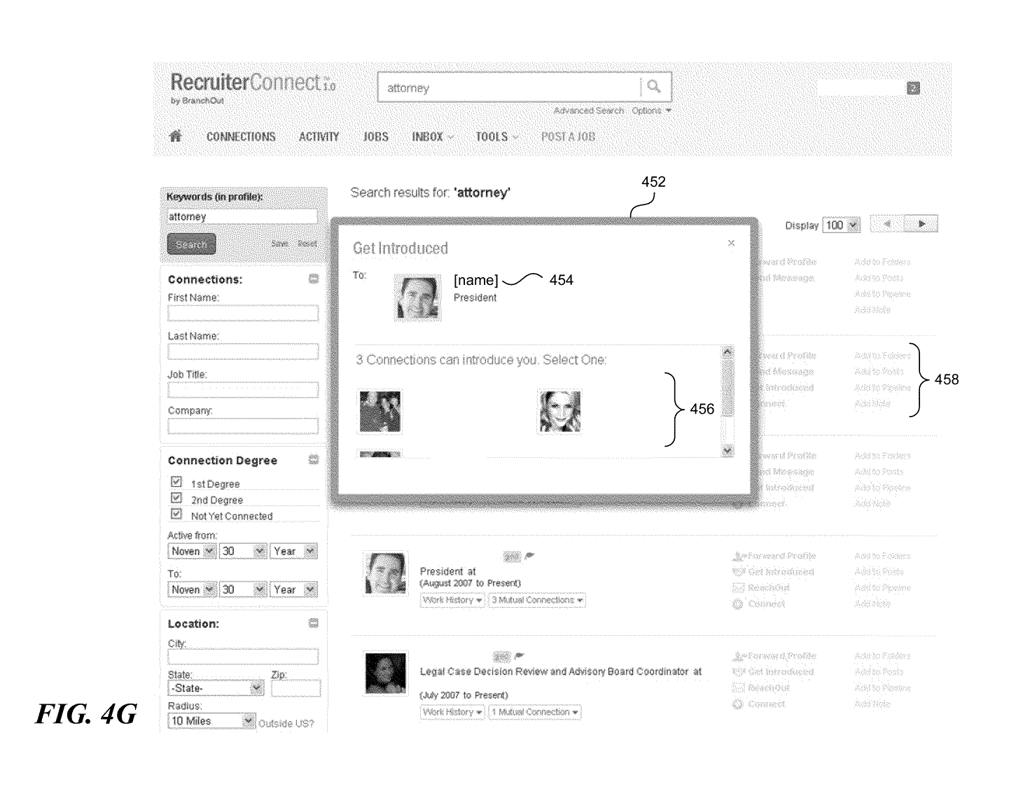

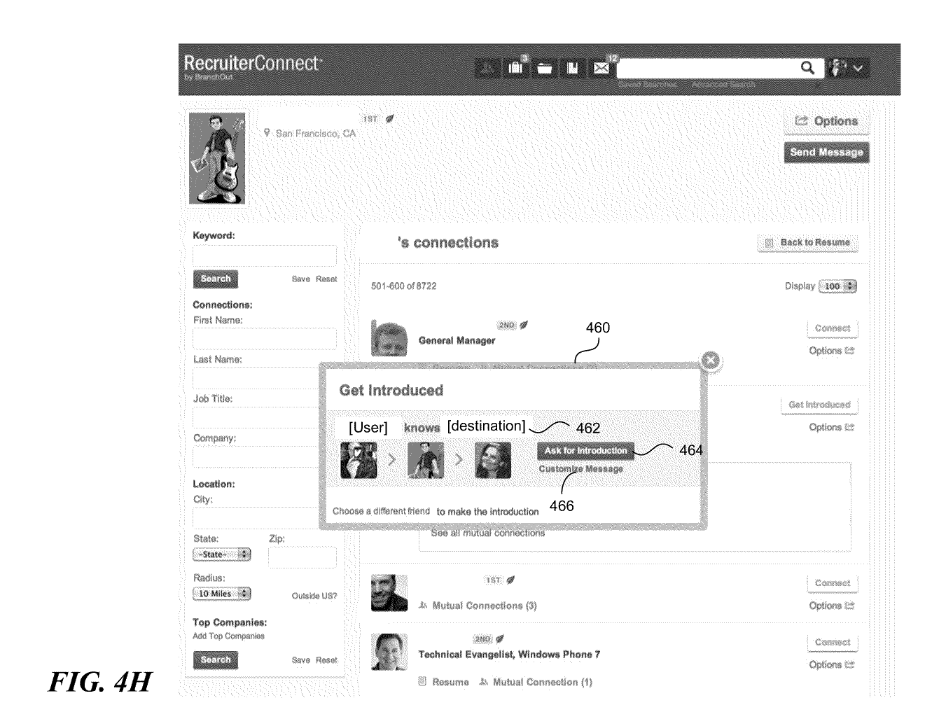

FIGS. 4A through 4H illustrate a suitable user interface for interacting with the connector system. The interface of FIG. 4A illustrates a connections screen (a “My Connections” tab), which shows user profiles (including user profile 402) corresponding to direct connections for a particular user of the system (referred to as the “originating user”). The interface displays basic information for each of the user profiles shown in the interface, such as the name 404, the degree of connection 406, and an icon 408 indicating which network the user profile is in (e.g., the first social network 106 or the second social network 108). The icon 408 indicates that the user profile is in the first social network 106. A second icon (not shown) corresponds to direct connections through the second social network.

The interface also includes links 410 and 412, which provide access to additional information associated with each user profile 402. In particular, link 410 enables a dropdown box that shows work history information for the user profile 402. The link 412 enables a dropdown box that lists mutual connections between the originating user and the user profile 402. A set of links 414 also provides connection options that the originating user may select for interacting with the user profile 402. The connection options are discussed in greater detail below. In general, the interface displays different connection options in the set of links 414 depending on the type of connection that exists between the originating user and the user profile 402.

FIG. 4B shows similar information corresponding to the root profile's “talent network” (a “Talent Network” tab). The talent network corresponds to the combined social graphs of a linked set of users from a particular enterprise, such as a particular public or private company, a local/county/state/federal governmental organization, a quasi-legal organization such as a club or affinity group, etc. Thus, the system may permit all users of the enterprise to be connected as described herein. The system further enables the enterprise to link a set of users who are part of a particular group, such as human resources or recruiting, to aggregate their social graphs. This group shares at least one common attribute or trait in common, such as organizational group within the enterprise (e.g. finance department), common affinity (e.g. science-fiction fan club), etc. The talent network treats direct connections for any team member as if they were direct connections of every team member. The talent network also includes direct connections made from former members of the team, even if that member is no longer part of the enterprise. In this way, the talent network functions as an institutional memory that allows the enterprise to maintain social network connections that are developed by any of its employees in the course of working for the enterprise. The system may designate such former members with a particular icon or other visual cue.

As with the user interface of FIG. 4A, the interface of FIG. 4B includes user profiles and associated information, such as the degree of connection and which network is used to make the connection. However, the set of links 418 to connection options in FIG. 4B may differ from the corresponding options of FIG. 4A because the type of connection between the root profile and the user profiles differs. In particular, the user profile 416 is a direct connection from a team member, rather than a direct connection from the originating user. Thus, the set of links 418 to connection options includes options to “Get Introduced” and “Connect” to the user profile 416, which would be redundant if the originating user were directly connected. Further details on such connections are provided below.

FIG. 4C is a representative user interface for performing a search over the users in the larger networks. A keyword box 420 allows a user to enter keywords to search for within user profiles in the connected social networks. A user may also enter search parameters by entering information into text boxes for first name 422, last name 424, job title 426, and company 428. The interface also includes checkboxes 430, which enable the user to narrow the search based on the degree of connection to the originating user. In some embodiments, this option filters the social network according to the social graph defined by the user's talent network, i.e., first degree connections include first degree connections through team members as well as the user's direct connections. The originating user may also narrow the search based on a time period that user profiles were active by selecting target dates using the date entry section 432. The interface also includes an input section 434 for narrowing results based on location information. Of course, other filters or query restrictions are possible. For example, if the system includes separate fields for skills or education in user profiles, the interface could also allow the user to narrow the search by looking for keywords in specific fields. The interface may also provide options to filter based on industry, seniority, education, and payscale. FIG. 4C shows results of a search based on a keyword of “legal” with no other restrictions.

FIG. 4D shows a user interface for viewing search results with a mutual connection displayed. As shown in FIG. 4D, the user has selected the link to display a mutual connection box 438 associated with user profile 436. The mutual connection box 438 displays a name and profile picture for each mutual connection between the user profile 436 and the originating user. In the case of the user interface of FIG. 4D, there is only one mutual connection between the originating user and the user profile 436.

FIG. 4E shows a user interface for viewing search results that include a user profile from the second social network. The interface of FIG. 4E is generally similar to the interfaces of FIGS. 4C and 4D; however, the user profile 440 shown in FIG. 4E includes an icon 442, which indicates that the user profile 440 is connected only through the second social network 108. (In the example of FIG. 4E, an “f” Facebook icon is shown, indicating that the second social network is Facebook, while the first social network is BranchOut, as indicated by the leaf icon.) In contrast, the other user profiles in FIG. 4E, as well as the profiles shown in the previous figures, were all members of the first social network.

FIG. 4F is a representative user interface for sending a direct message from the originating user to a direct (i.e., first degree) connection. The user interface includes a send message window 444, which may be launched by a user selecting a “send message” link from the set of links 450 to available connection options. The send message window 444 is pre-populated with the selected user profile 451. The send message window 444 also includes text boxes 446 and 448 for entering the message subject and content, respectively.

FIG. 4G is a representative user interface for requesting an introduction to a user profile not directly connected to the originating user. The user interface includes a get introduced window 452, which may be launched by a user selecting a “get introduced” link from the set of links 458 to available connection options. As with the interface of FIG. 4F, the get introduced window 452 may be pre-populated with the selected user profile 454. The get introduced window 452 displays a listing 456 of all mutual connections between the originating user and the destination user profile. The user then selects a connection from the listing 456 to provide the introduction. In some embodiments, the system sends a single message to both the destination user profile and the user profile of the connection being asked to provide the introduction. In other embodiments, the system sends separate messages to each user profile. In this embodiment, the user may tailor the content of the messages for each recipient. In some embodiments, the system may also send the messages using different delivery mechanisms. For example, the system may send an e-mail message to the connection being asked to provide the introduction and a limited message (discussed below) to the destination user profile.

FIG. 4H is a representative user interface that may be displayed after a user has selected a particular connection to provide an introduction. The user interface includes an updated get introduced window 460 which displays the selected connection and allows the user to request an introduction to the selected destination user profile 462. The user makes the request by selecting the “Ask for Introduction” button 464. The user interface also provides a link 466, which allows the user to customize the request message sent to the selected connection.

FIG. 4I is a representative user interface for sending a limited message (shown as a “ReachOut message” in the Figure) to a user profile not directly connected to the originating user. The message may be limited in various ways, such as content, subject, message length, or number of messages that can be sent. The messages may also be anonymized such that the destination user will receive the message but will not receive identifying information associated with the originating user. In some embodiments, the system may allow users to block or restrict whether they can receive limited messages, for example by modifying privacy settings.

The user interface of FIG. 4H includes a ReachOut message window 468, which is pre-populated with the selected user profile 470. The ReachOut message window 470 is displayed in response to the originating user selecting the “ReachOut” link from the set of links 474 to available connection options. The ReachOut message window 468 includes text boxes 472 and 474, which allow the originating user to enter or edit the message subject and content, respectively. In some implementations, the interface further limits the message by preventing the originating user from customizing the subject or content of the message. For example, the interface may restrict the message content by providing only a limited set of messages that the originating user can select from.

The user interface also provides a quota section 476, which displays the number of ReachOut messages that the user has available. In some implementations, each user is granted a limited number of ReachOut messages that may be sent within a month (or other time period). The system may allow some or all unused messages to roll over to the following month. In some implementations, the system allows the user to purchase additional messages by paying a fee. The system may also vary the cost of sending ReachOut messages depending on the job or role of the selected user; for example, the system may impose a higher cost to send ReachOut messages to a CEO or other high-ranking executive in a company. These limitations reduce the risk that unscrupulous users will abuse the network by sending overly large or aggressive mass mailings. In some implementations, the system may provide a mechanism to refund a message to the user's message quota if the recipient does not respond to the message within a specified time period, such as seven days.

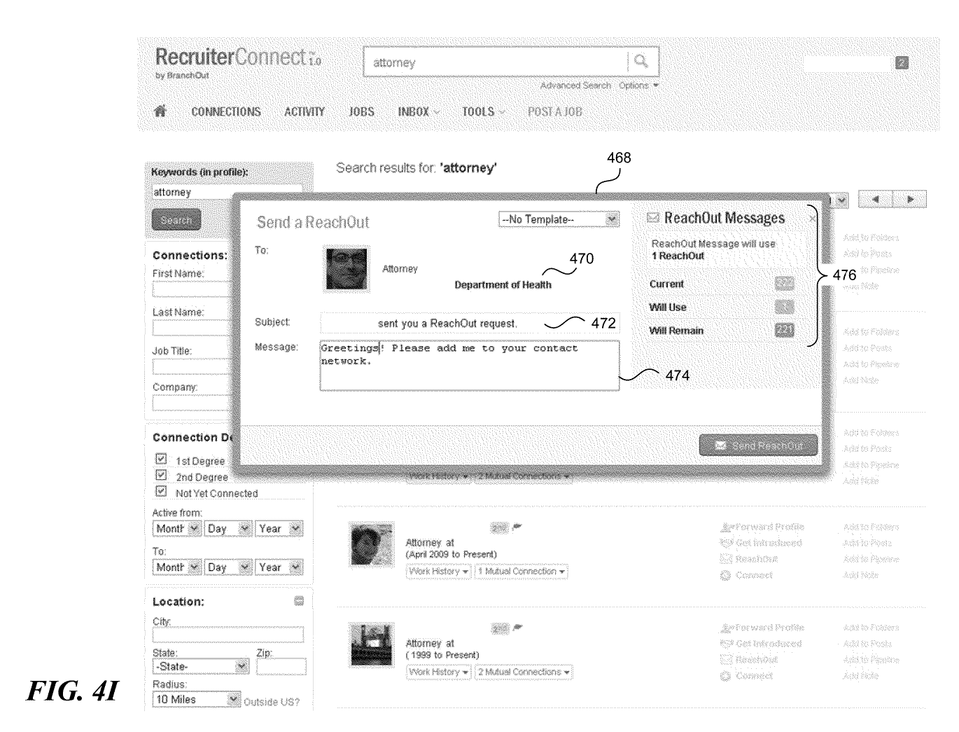

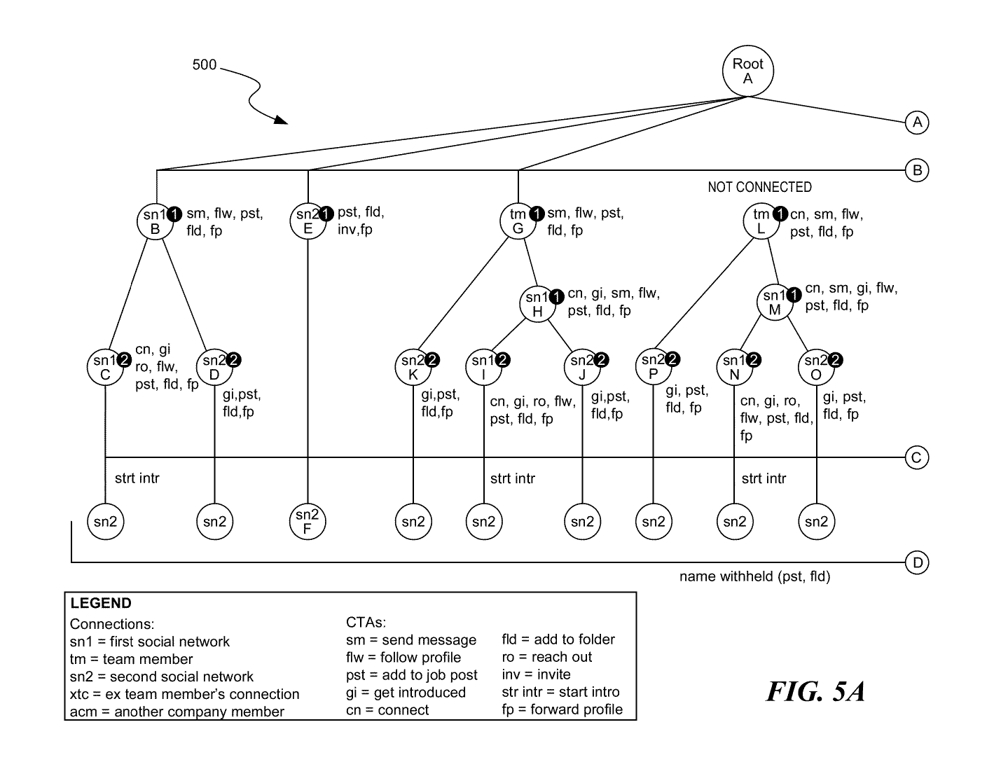

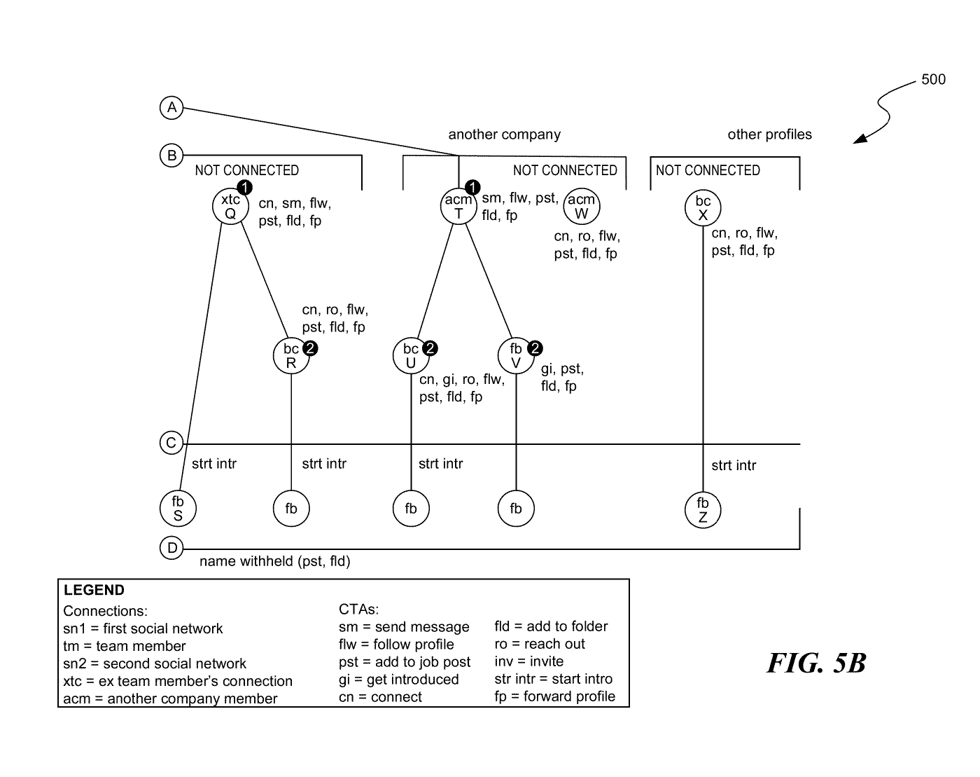

FIGS. 5A and 5B together illustrate a combined social graph 500 that combines multiple social networks into a single social graph. Although the modified social graph uses two social networks, a similar social graph could be generated by combining three or more social networks. FIGS. 5A and 5B depict the various types of connections in the combined social graph and connection options available for connecting with various user profiles in the social graph. For relatively close connections in the modified social graph 500, a number indicates the degree of connection from the root profile. For example, user profile B has a “1” associated with it because it is a first degree connection to the root profile A. Similarly, user profiles C and D each have a “2” associated with them because they are second degree connections to the root profile A. No degree number is included for more distant connections. FIGS. 5A and 5B also include an indicator of which network the particular user profile is a member of. A profile that is a connection through both social networks will generally allow for contact through the most permissive of the connection options (the first social network, in the implementation of FIGS. 5A and 5B).

As shown in FIGS. 5A and 5B, the system provides for a number of connection options for communicating between users. The connection options include:
SM: Send a message. This message is a direct message from the root profile A to a selected user profile. Because the SM option is provided only for direct connections, the user may send an unlimited number of messages to users where the SM option is available. In general, the system does not anonymize direct messages.
FLW: Follow profile. The FLW option allows the originating user to select a user profile to follow. The originating user receives updates whenever the selected user profile is updated, such as by adding new job experience or contact information.
PST: Add to a job post. In one implementation, the connector system connects multiple social networks for use in recruiting. In this implementation, the PST option allows a user to generate a job posting and link the selected user profile to that job posting for later reference.
RO: ReachOut. The RO option allows the originating user to send a limited message to a user profile in the first network that is not a direct connection. As discussed above, the system may limit the number of ReachOut messages that are available to a particular user over a particular time period. These messages may be allocated for a specific time period (e.g., a specified number per month) or on a rolling basis. These messages are typically delivered as messages in the first social network and may also trigger an e-mail to a registered e-mail account associated with the selected user profile. In some cases, the ReachOut message may be anonymized to remove some or all of the originating user's personal information.
GI: Get introduced. The GI option allows the originating user to request an introduction to a second degree connection through a common connection or a team connection. For example, this option may be used to request an introduction to a friend of a friend in one of the social networks. The GI option sends a request to get introduced to the mutual connection as a message in either the first social network or the second social network. The message indicates that the requestor would like to be introduced to the target user and provides the mutual connection an option to perform the introduction. For example, this option may be useful for communicating with a connection of a team member. In this case, the GI option allows the user to request the team member to provide an introduction to one of his first degree connections.
STRT INTR: Start introduction. The STRT INTR option allows the originating user to ask an unknown person (i.e., not a current connection to the user or a team member) to provide an introduction to a selected user profile. Thus, the STRT INTR option is similar to the GI option, but sends the introduction request to a user profile that is not connected to the originating user profile to request an introduction to a target user. The user profile receiving the request for introduction may then respond by rejecting the introduction or providing the user with the introduction to the target user. In some embodiments, the STRT INTR option is subject to the same limitations as the RO option. For example, the system may limit the number of times a user may use the STRT INTR option during a particular time period. In some embodiments, the system may anonymize the introduction request, such that the user cannot see the third party's name or other identifying information.
CN: Connect to target user profile. The CN option is provided when two users of the first social network are not directly connected and allows the originating user to request a direct connection with the selected user profile. The selected user profile may elect to accept the connect request, which adds the selected user profile as a first-degree connection to the originating user profile. The connection invitation is generally visible to the target user on a profile page, dashboard, or notifications box for the first social network and may also include a notification sent via e-mail, although other connection or communication options are possible, such as voicemail, video conferencing (e.g. Skype), animated avatars, text message, chat, etc.
FLD: Add to folder. The FLD option allows the originating user to save a link to the target user profile for later access. The system may allow the originating user to create multiple folders for different purposes or with different ratings. The folders contain links to the associated user profiles and may be accessed at a later time for further review.
INV: Invite. The INV option allows a member of the first social network to send an invitation to join the first social network. This option is generally provided for first degree connections through the second social network. The invitation may be sent to the selected user profile as a public posting to the selected user profile or as a private message to the user profile.
FP: forward profile. The FP option allows the originating user to forward a link to the selected user profile to another user of the first social network.

In addition to the connection options discussed above, the system may also selectively display user profile information based on the degree and type of connection between the originating user and other users in the system. For example, the system may display more detailed information for direct connections than for indirect connections. The system may also display different levels of information depending on whether the other user profiles are in the first social network or the second social network.

The social graph 500 of FIGS. 5A and 5B illustrates many types of connections that may be made using the system. For conciseness, only a subset of these connections will be described herein. One skilled in the art will understand that the description herein may be applied to other connections not shown in the figures or shown in figures but not explicitly described. Moreover, some options, such as adding to a job post, adding to a folder, and forwarding a profile, are common across most types of connections and will only be discussed for connections where they are not provided.

As shown in FIG. 5A, a direct connection exists between the root profile A and user profile B, which is in the first social network. Based on this connection, the originating user A may send a message, follow, add to a job post, add to a folder, or forward the profile to another user. User profile B is directly connected to user profile C, which is in the first social network, and user profile D, which is in the second social network. These two user profiles are, therefore, second degree connections from the root profile A. Because user profile B is a member of the first social network, the root profile A may send a connection request, a get introduced request, or a ReachOut message to user profile C. Connection options are generally more limited for users in the second social network; therefore, the root profile A can send a get introduced request, but can not directly connect to user D.

User profile E is directly connected with root profile A through the second social network. As discussed above, the system limits connection options for connections through the second social network. Therefore, the system provides an option to invite user profile E to join the first social network, but does not provide direct connection or messaging options.

User profiles G and L are team members of the root profile A, although user profile L is not directly connected to the root profile A. However, both profiles are treated as direct connections based on the enterprise functionality discussed above. Furthermore, first-degree connections to team members through the first social network are also treated as first-degree connections of the root profile A. Direct connections from team members through the second social network may be treated as first- or second-degree connections from the root profile A, depending on system configuration. As discussed above, this relationship is one way. That is, the originating user profile A can see user profile H and user profile M as direct connections, but user profile H and user profile M will not see user profile A as a direct connection.

The system displays profile information and connection options as if user profile H and user profile M were direct connections to the root profile A. Thus, the root profile A can send a direct message to either user profile. However, because these user profiles are not actually direct connections, the system also provides connection options to allow the root profile A to connect or get introduced. Thus, connections through a team member are effectively hybrid connections that incorporate connection options appropriate for both first- and second-degree connections.

Turning to FIG. 5B, user profile Q is a former team member of the originating user A. This relationship allows the originating user A to see the former team member as a current team member, but provides more limited options for communicating with the former team member's connections. In effect, the former team member is treated as if there were a regular connection to the originating profile A, even though no direct connection exists.

The system treats users at other companies (e.g., user profiles T and W) similarly to other types of users. For example, a direct connection at another company is treated the same as a direct connection at the current company. That is, the connection options for user profile T are the same as the connection options for user profile B, because they are both direct connections and both are members of the first social network. Similarly, second degree connections to user profiles U and V are treated the same as second degree connections to user profiles C and D of FIG. 5A. In the case of user profile W, there is no direct connection to the originating user A, but the user profile W is a member of the first social network. Because of this common membership in the first social network, the system provides the connect option and the ReachOut message option for interacting with user profile W. The system provides similar options for communicating with user profiles in the first social network who are not members of other companies, such as user profile X.

The system provides a more limited set of connection options for user profiles that are significantly more distant from the root profile A. For example, user profiles F in FIGS. 5A and Z in FIG. 5B are relatively distant from the originating user A and are only members of the second social network. Because of the distance of the connection to these user profiles and their membership only in the second social network, the system significantly limits the connection options provided to the originating user A. For user profiles F and Z, the system provides a start introduction connection option, which allows the originating user to initiate an introduction with a selected user profile through a user profile that is not in the originating user's social grap. The level of distance that triggers this option may be varied depending on the needs of the system. In the configuration of FIGS. 5A and 5B, this option is enabled for second-degree or greater connections through the second social network and for third-degree or greater connections that include the first social network.

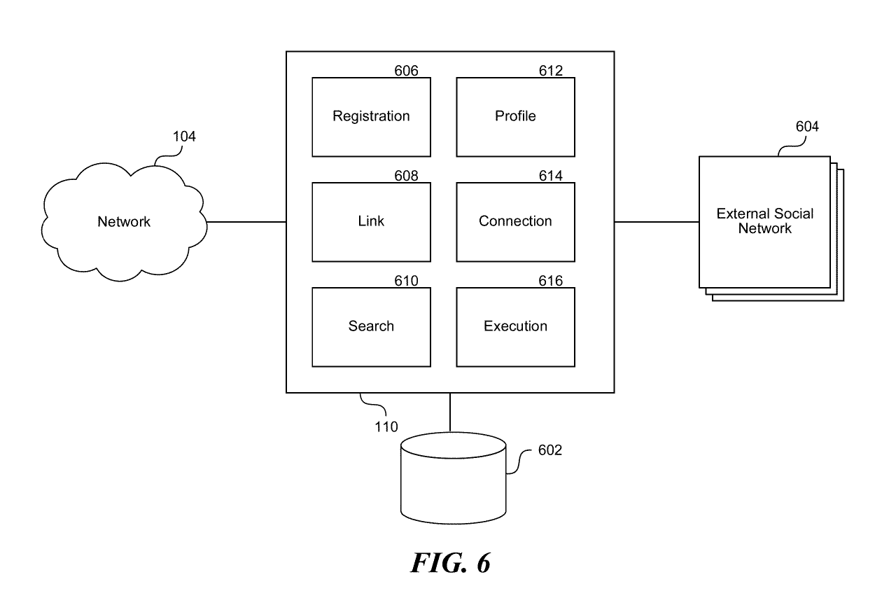

FIG. 6 is a logical block diagram of the connection component 110 and its associated components. The connector system may be executed, for example, using the memory and processor of FIG. 3. Although the various modules are depicted in a single device, the modules are not necessarily physically collocated. In some embodiments, the various modules may be distributed over multiple physical devices. Similarly, the data storage could be implemented using local storage components, such as a hard drive or flash memory, or using remote storage, such as a web server accessible through the internet. The code to support the functionality of this system may be stored on a computer-readable medium such as an optical drive, flash memory, or a hard drive. Aspects of the system may be implemented as software, firmware, hardware, or as a combination of these.

The connection component 110 communicates with clients 101 (FIG. 1) through the network 104 to receive and respond to requests. The connection component 110 also communicates with one or more external social networks 604 to retrieve user profile and social graph information. The connection component 110 combines this information to generate the combined social graph discussed above. The connection component uses a storage component 602 to store connection information for connecting with the external social networks 604. The storage component 602 may be implemented as a database, a set of files in a file system, or any other storage method known in the art. The connection information may include user credentials or security tokens needed to indicate that the connection component 110 is allowed to access particular information. Mechanisms for connecting with the external social networks 604 are discussed in greater detail below with reference to FIG. 10. The connection component 110 may also manage an internal social network. In this implementation, the storage component 602 also stores user profile information and social graph information for the internal social network.

The connection component 110 includes a registration component 606, which is configured to receive user data for a user profile in the internal social network and store the user data in the storage component 602. The registration component 606 is also configured to store connection information for social graphs in the internal social network. The connection component 110 includes a link component 608, which is configured to link user profiles stored by the registration component 606 with corresponding user profiles in the external social networks 604. The link component 608 receives user credentials or access tokens from the user to authorize the connection component 110 to communicate with the external social networks 604. The link component 608 stores link information, including credentials or access tokens, in the storage component 602.

The connection component 110 also includes a search component 610, which is configured to determine a set of matching user profiles from the internal social network and the external social networks 604 based on a specified set of search parameters. The external social networks 604 may be, for example, the second social network discussed above. As shown in FIGS. 4A-4H, these search parameters may include keywords, degree of connection, periods of activity, physical location, industry, seniority, education, and payscale. The search component 610 uses standard search mechanisms known in the art to find matching profiles that satisfy the specified set of search parameters. Once the set of matching user profiles have been determined, the search component 610 provides at least part of the set to the client via the network 104. In this step, the search component 610 interacts with a profile component 612, which is configured to provide profile information for the user profiles in the set of user profiles generated by the search component 610. In general, the information provided by the profile component 612 will vary depending on the network membership of each user profile and a degree of connection between the originating user and the individual profile being provided. For example, the profile component 612 may provide extensive user information for users of the internal social network and a more limited set of information for users in an external social network 604. The profile component 612 may also provide more limited information for user profiles that are more distant from the originating user. For example, the profile component 612 may only provide city and state or job title for these distant users.

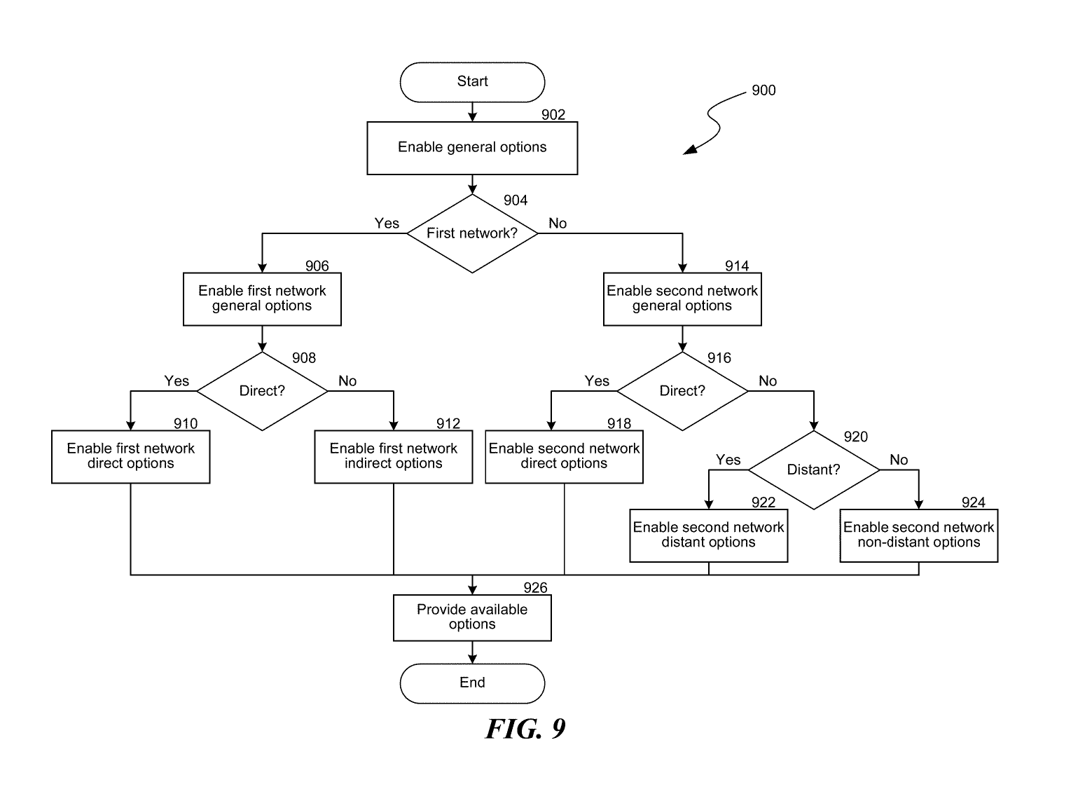

The connection component 110 also includes a connection option component 614, which is configured to determine connection options to provide for each user profile in the set of user profiles. The process for determining available connection options is discussed below with reference to FIG. 9. After the user selects a connection option, an execution component 614 receives the selection and executes a process associated with the selected connection option.

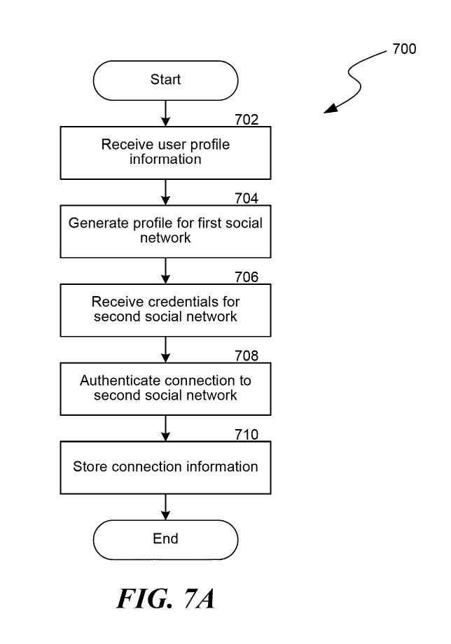

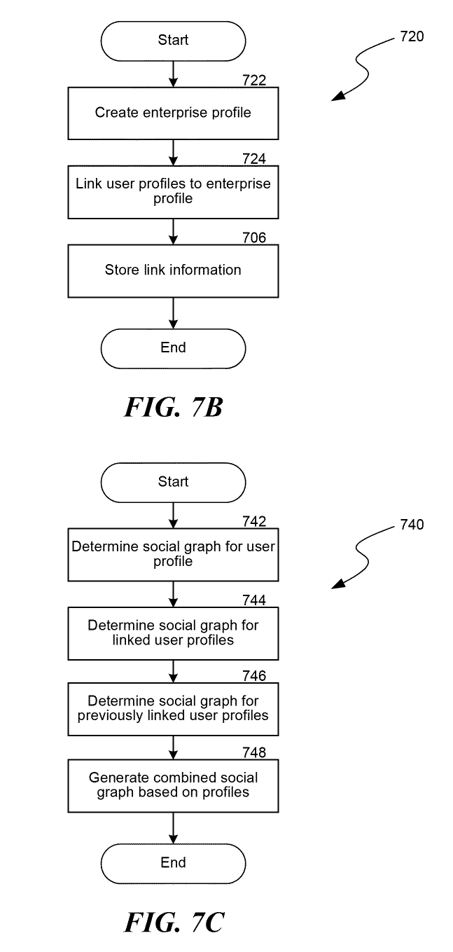

FIG. 7A is a flowchart of a process 700 for registering a user with the connector system 110. The process begins at block 702, where the system receives user profile information for a new user. The user profile information generally includes personal information such as name, geographic location, employment information, education, etc. Processing then proceeds to block 704, where the system generates a user profile based on the user profile information. The system may also generate a social graph in an internal social network based on connection information provided by the user. The system stores the user profile and social graph in the storage component 602 (FIG. 6).

Processing then proceeds to block 706, where the system receives user credentials (or other authorizing information) for an external social network. In one implementation, the user credentials include a user name and password that can be used to access the external social network. In other implementations, the system opens a network connection to the external social network and redirects the user to the external social network to authorize information sharing with the connection component. Processing then proceeds to block 708, where the system authenticates a connection to the second social network. In this step, the system may receive a token or other authorization from the second social network to be used when the system interacts with the external social network on behalf of the user. In block 710, the system stores this connection information in the storage component 602 in association with the user's profile. The process then exits. The process of interacting with the external social network is discussed in greater detail below with reference to FIG. 10.

The process 700 discloses a system in which the user creates a profile in the first social network before linking the profile to the second social network. However, in some embodiments, the user may join the first social network as an add-on to the second social network. For example, the first social network may be implemented using an application added to the user's profile in the second social network. In these embodiments, the user initially logs in to the second social network and elects to add an application associated with the first social network. The user may then create and store a new user profile for the first social network. In this case, the system automatically links the user's profile in the second social network with the new user profile in the first social network without requiring additional steps from the user.

FIG. 7B is a flowchart of a process 720 for linking user profiles through an enterprise profile. Processing begins at block 722, where the system creates an enterprise profile. An enterprise profile may be generated by anyone authorized to act on behalf of the enterprise, such as a manager for a particular department, or by the operator of the system on behalf of the enterprise. In some implementations, the system allows the enterprise to create multiple profiles for different teams within the enterprise, such as human resources, engineering, etc. Processing then proceeds to block 724, where the system links multiple user profiles for employees (or other people associated with the enterprise) to the enterprise profile. Processing then proceeds to block 726, where the system stores the link information in association with the enterprise profile. The process then exits.

FIG. 7C is a flowchart of a process 740 for generating an enterprise social graph. The enterprise social graph is the social graph for the enterprise as a whole, which combines social graphs for all user profiles linked to the enterprise profile. Processing begins at block 742, where the system determines a social graph for the originating user profile. As discussed above, this social graph may be stored locally in the storage component 602, retrieved from an external social network, or a combination of both. Processing then proceeds to block 744, where the system determines social graphs for all linked user profiles. In this step, the system detects that the originating user profile is linked to an enterprise profile and determines other user profiles linked to the enterprise profile. The system then determines social graphs for each of the linked user profiles similarly to the process discussed above for block 742. Processing then proceeds to block 746, where the system determines social graphs for user profiles that were previously linked to the enterprise profile. In some implementations, the system allows the enterprise profile to retain a link to social graphs for linked user profiles even after the individual associated with the user profile has left the enterprise. In one implementation, the system only retains connections that were added during the time the individual was associated with the enterprise. After the system has determined the relevant social graphs, processing proceeds to block 748, where the system generates the combined social graph (i.e., the enterprise social graph) based on the social graphs determined in the previous steps. In some implementations, the system combines the social graphs by treating direct connections from any linked user profile as if they were direct connections for every linked user profile. The enterprise social graph may then be provided to a user for display (such as in FIG. 4B) or used as a basis for other functionality, such as search. The process then exits.

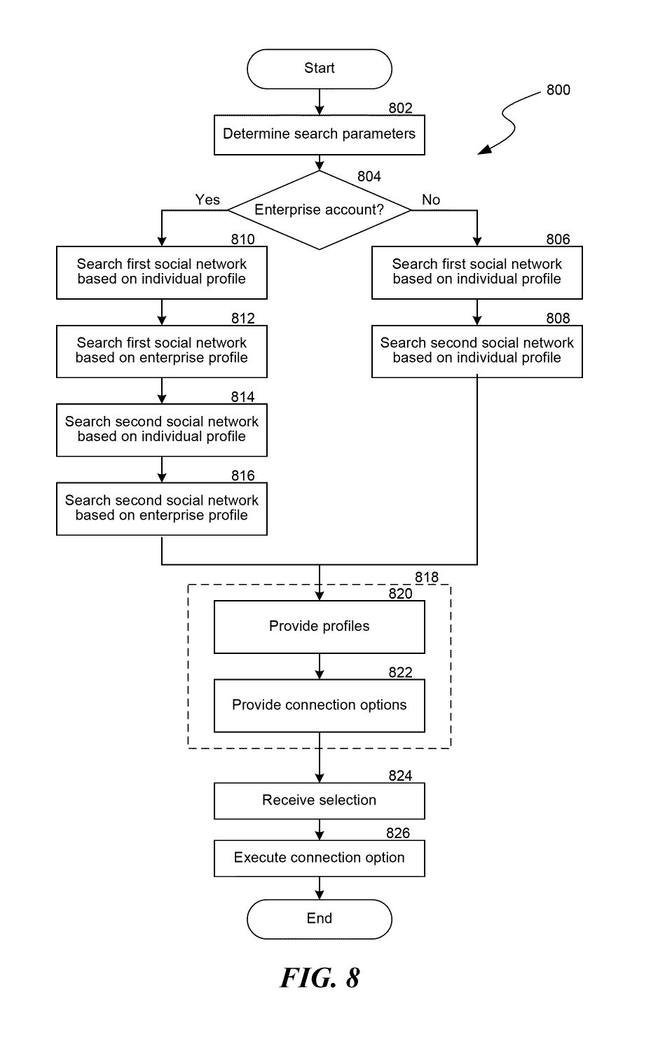

FIG. 8 is a flowchart of a process 800 for searching for user profiles and providing the results to the originating user. Processing begins at block 802, where the system determines a set of search parameters to be applied. Typically, the user will provide the search parameters by entering information into a user interface, such as the user interfaces of FIGS. 4A-4H. The user interface may be web-based, so that the user can access it with a web browser, or implemented in a dedicated application on a personal computer or other device.

Processing then proceeds to decision block 804, where the system determines whether the originating user profile is linked to an enterprise account. As discussed above, accounts linked in an enterprise receive special treatment because the system combines social graphs for all team members in the enterprise. If the originating user profile is not linked to an enterprise account, processing proceeds to block 806, where the system searches the first social network based on the social graph for the individual's user profile. This initial search uses access permissions granted to the originating user profile and prioritizes results based on the originating user profile's social graph, although other sorting/prioritization of the results are possible. Processing then proceeds to block 808, where the system searches the second social network based on the social graph for the originating user. Based on these two steps, the system generates a set of resulting user profiles that will be handled later in the process. One skilled in the art will appreciate that the above steps may be repeated for any additional social networks connected to the system. In some embodiments, the system maintains a single social graph for each user that combines the social graphs from the individual social networks. In these embodiments, the system searches the combined social graph in a single step, rather than searching each graph separately, as discussed above.

If the system determines at block 804 that the originating user profile is linked to an enterprise account, processing proceeds instead to block 810, where the system searches the first social network based on the social graph of the originating user profile using a process similar to that of block 806. Processing then proceeds to block 812, where the system searches the first social network based on the enterprise profile for the originating user's team. In this step, the system searches the broader social graph generated by combining social graphs for every team member linked to the enterprise account. The overall processing is similar to the search of block 810, except for the larger social graph. Processing then proceeds to block 814, where the system searches the second network based on the social graph associated with the individual profile. Processing then proceeds to block 816, where the system searches the second network based on the enterprise profile. As discussed above, some of these steps may be combined if the system maintains a single social graph across the multiple social networks. Typically, the system will maintain separate social graphs for the individual profile and the enterprise profile.

In either case, once the system has determined a set of resulting user profiles, processing proceeds to combined block 818, where the system provides the results of the search to the user. The method for providing results to the user will vary depending on how the user is interacting with the system. For example, if the user is accessing the system through a web browser, the system provides web pages with some or all of the results. Alternatively, if the user is interacting through a dedicated application, the system communicates with the application to provide the results for display in the application's user interface.

Within aggregate block 818, the process includes block 820, in which the system provides the resulting profiles and information generated by the searches described above. The profile information provided varies depending on network membership for each user profile, degree of connection for each user profile, and other privacy settings associated with the user profiles. Processing then proceeds to block 822, where the system displays connection options associated with each user profile. The connection options provided depend on similar characteristics, including network membership for each user profile, degree of connection, and other privacy settings. This step is described in greater detail below with reference to FIG. 9.

Processing then proceeds to block 824, where the system receives a user selection of a particular connection option. Processing then proceeds to block 826, where the system executes the selected connection option. The process 800 then exits.

FIG. 9 is a flowchart of a process 900 for determining connection options to provide for individual user profiles. The process 900 is one implementation of step 822 of FIG. 8, although others are possible. In general, the process 900 is executed to determine connection options each user profile generated during the search process of FIG. 8. Processing for each user profile begins at block 902, where the system enables general options that are provided for communicating with all user profiles. This may include, for example, allowing the originating user to add the profile to a folder or to a job post.

Processing then proceeds to decision block 904, where the system determines whether the selected user profile is a member of the first social network. If the selected user profile is a member of the first social network, processing proceeds to block 906, where the system enables general options for the first social network. These general options may include, for example, the follow profile and forward profile options. General options for each social network are selected based on the particular expectations of the social network's users. For example, the first social network may be intended for a specific purpose, such as job searching or recruiting. In this type of network, users will generally expect that more of their information may be made available to other users who are looking for qualified candidates. In contrast, users of the second social network may expect that their information will be shared with a smaller group; therefore, the system will generally allow fewer connection options with those users.

Processing then proceeds to decision block 908, where the system determines if the originating user profile is directly connected to the selected user profile. If the connection is direct, processing proceeds to block 910, where the system enables the direct options for the first social network. These may include, for example, enabling the option to send a direct message to the selected user profile. Alternatively, processing proceeds to block 912, where the system enables indirect options for the first social network. These may include requesting an introduction, sending a ReachOut message, or sending a connect request.

If the system determines that the target user profile is not a member of the first social network, processing instead proceeds to block 914, where the system enables the general options for the second social network. Processing then proceeds to decision block 916, where the system determines whether the connection to the target user profile is indirect. If the connection is direct, processing proceeds to block 918, where the system enables direct connection options for the second social network. This may include, for example, an option to send an invitation to the selected user profile to join the first social network. If the connection is indirect, processing proceeds instead to block 920, where the system determines whether the selected user profile is distant—i.e., whether the number of degrees between the originating user profile and the selected user profile is greater than a threshold value. In some implementations, the threshold value is two, i.e., a degree of connection greater than second degree is treated as being a distant connection. If the connection is considered distant, processing proceeds to block 922, where the system enables the distant options for the second social network. These options may include, for example, enabling the originating user to request an introduction through a user profile the originating user is not connected to. If the connection is not distant, processing proceeds to block 924, where the system enables the non-distant options for the second social network. Once all of the available connection options have been determined, the system provides the options to the user (block 926) and exits the process.

Typically, the connection component 110 (FIG. 6) communicates with the external social networks 604 using standard communication protocols, such as OAuth 2.0. The connection component 110 transmits requests to the external social networks 604 according to APIs specified by the providers for the external social networks 604. For example, when a user of the second social network adds an application for the first social network, the first social network uses an OAuth Dialog associated with the second social network to request permissions to access the required data. If the user accepts, the second social network calls back to the first social network with an authorization code, which the first social network exchanges for an OAuth access token. This token allows the first social network access to the user's professional and educational information, profile location, education and work information for that user's friends, as well as the ability to post to that user's wall and create events for that user. In some embodiments, the first social network accesses the API using HTTP or HTTPS calls.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to pursue additional claims after filing this application to pursue such additional claim forms, in either this application or in a continuing application.

I/We claim:

1. A computer-implemented method for facilitating connection between users of social networks, comprising:
linking a first user profile for a first social network to a second user profile for a second social network,
wherein the first user profile includes a first social graph connecting the first user profile to a first set of associated user profiles for the first social network;
wherein the second user profile includes a second social graph connecting the second user profile to a second plurality of associated user profiles for the second social network;
determining a target user profile,
wherein the target user profile is a member of the first social network, the second social network, or both the first social network and the second social network; and
providing at least one communication option for communicating with a target user associated with the target user profile,
wherein the at least one communication option is selected from multiple available communication options, and
wherein the at least one communication option is selected based on:
whether the target user profile is in the first social network or the second social network and,
whether the target user profile is directly connected to the first user profile or the second user profile.

2. The method of claim 1, wherein:
the first user profile is associated with an organization;
the organization is associated with a third user profile in the first social network; and
the first social graph comprises connections from the first user profile and connections from the third user profile, such that direct connections from the third user profile are treated as direct connections from the first user profile.

3. The method of claim 1, wherein the target user profile is not directly connected to the user profile, wherein an intermediate user in the first social graph or the second social graph is directly connected to the target user profile, and wherein the at least one communication option includes requesting the intermediate user to provide an introduction to the target user profile.

4. The method of claim 3, wherein the target user profile is more than a threshold number of degrees separated from the user profile and wherein the intermediate user is not directly connected to the user profile.

5. The method of claim 1, wherein the target user profile is directly connected to the user profile though the first social graph and wherein the at least one communication option includes sending a direct message to the target user profile.

6. The method of claim 1, wherein the target user profile is a member of the first social network and is not directly connected to the user profile and wherein the at least one communication option includes requesting a direct connection to the target user profile.

7. The method of claim 1, wherein the target user profile is not directly connected to the user profile and wherein the at least one communication option includes registering to follow updates to the target user profile.

8. The method of claim 1, wherein the target user profile is not directly connected to the user profile and wherein the at least one communication option includes sending a limited message to the target user profile, wherein the limited message is restricted based on at least one of message content or number of messages that can be sent.

9. The method of claim 1, wherein the target user profile is not a member of the first social network and wherein the at least one communication option includes sending an invitation to the first social network to the target user profile.

10. The method of claim 1, further comprising displaying information relating to the target user profile, wherein the information displayed is determined based on privacy settings associated with the first social network or the second social network and wherein the privacy settings allow more information to be displayed when the target user profile is in the first social network than when the target user profile is in the second social network.

11. The method of claim 1, wherein the at least one communication option is further selected based on whether a degree of separation between the user profile and the target user profile is greater than a pre-determined threshold and wherein the pre-determined threshold is greater than two.

12. A computer-readable medium containing instructions for facilitating connection between users of social networks in a computing system including a processor and an associated storage area, by a method comprising:
storing a user profile associated with a first social network and a second social network,
wherein the user profile includes a first social graph connecting the user profile to a first set of associated user profiles for the first social network and a second social graph connecting the user profile to a second set of associated user profiles for the second social network;
determining a set of user profiles from the first social network and the second social network matching a specified set of search parameters;
providing information corresponding to individual user profiles of the set of user profiles, the information provided varying based on a network membership of the individual user profile and a degree of connection between the user profile and the individual profile;
providing at least one connection option for connecting with individual user profiles, the at least one connection option being determined based on a network membership of the individual user profile and a connection degree between the user profile and the individual user profile;
receiving a selection of a connection option of the at least one connection option; and
executing a process associated with the selected connection option.

13. The computer-readable medium of claim 12, wherein providing at least one connection option comprises determining that the individual user profile is not directly connected to the user profile and that an intermediate user in the first social graph or the second social graph is directly connected to the individual user profile, and wherein the at least one connection option includes requesting the intermediate user to provide an introduction to the individual user profile.

14. The computer-readable medium of claim 13, wherein the intermediate user is not directly connected to the user profile.

15. The computer-readable medium of claim 12, wherein providing the at least one connection option comprises determining that the individual user profile is directly connected to the user profile though the first social graph and wherein the at least one connection option includes sending a direct message to the individual user profile.

16. The computer-readable medium of claim 12, wherein providing the at least one connection option comprises determining that the individual user profile is a member of the first social network and is not directly connected to the user profile and wherein the at least one connection option includes requesting a direct connection to the individual user profile.

17. The computer-readable medium of claim 12, wherein providing the at least one connection option comprises determining that the individual user profile is not directly connected to the user profile and wherein the at least one connection option includes at least one of registering to follow updates to the individual user profile or sending a limited message to the individual user profile, wherein the limited message is restricted based on at least one of message content or number of messages that can be sent.

18. The computer-readable medium of claim 12, wherein providing the at least one connection option comprises determining that the individual user profile is not a member of the first social network and wherein the at least one connection option includes sending an invitation to the first social network to the individual user profile.

19. The computer-readable medium of claim 12, wherein the information displayed for the individual user profiles is determined based on privacy settings associated with the first social network or the second social network and wherein the privacy settings allow more information to be displayed when the individual user profile is in the first social network than when the individual user profile is in the second social network.

20. The computer-readable medium of claim 12, wherein the at least one connection option is further determined based on whether a degree of separation between the user profile and the individual user profile is greater than a pre-determined threshold, wherein the pre-determined threshold is greater than two.

21. An apparatus for facilitating connection between users of social networks, comprising:
a processor;
a storage component;
a registration component configured to register a first user profile for a first social network,
wherein the first user profile includes a first social graph connecting the first user profile to a first set of associated user profiles for the first social network;
a linking component configured to link the stored first user profile to a second user profile for a second social network,
wherein the second user profile includes a second social graph connecting the second user profile to a second plurality of associated user profiles for the second social network;
a search component configured to determine a target user profile,
wherein the target user profile is a member of the first social network, the second social network, or both the first social network and the second social network; and
a connection component configured to provide at least one communication option for communicating with the target user profile,
wherein the at least one communication option is selected from multiple available communication options, and
wherein the at least one communication option is selected based on whether the target user profile is in the first social network or the second social network and whether the target user profile is directly connected to the first user profile or the second user profile.

22. The apparatus of claim 21, wherein the target user profile is not directly connected to the user profile, wherein an intermediate user in the first social graph or the second social graph is directly connected to the target user profile, and wherein the at least one communication option includes requesting the intermediate user to provide an introduction to the target user profile.

23. The apparatus of claim 21, wherein the target user profile is directly connected to the user profile though the first social graph and wherein the at least one communication option includes sending a direct message to the target user profile.

24. The apparatus of claim 21, wherein the target user profile is a member of the first social network and is not directly connected to the user profile and wherein the at least one communication option includes requesting a direct connection to the target user profile.

26. The apparatus of claim 21, wherein the target user profile is not a member of the first social network and wherein the at least one communication option includes sending an invitation to the first social network to the target user profile.

27. The apparatus of claim 21, further comprising a profile component configured to provide information relating to the target user profile, wherein the information provided is determined based on privacy settings associated with the first social network or the second social network and wherein the privacy settings allow more information to be displayed when the target user profile is in the first social network than when the target user profile is in the second social network.

28. The apparatus of claim 21, wherein the at least one communication option is further selected based on whether a degree of separation between the user profile and the target user profile is greater than a pre-determined threshold and wherein the pre-determined threshold is greater than two.

29. An apparatus for facilitating connection between users of social networks, comprising:
means for storing a user profile associated with a first social network and a second social network,
wherein the user profile includes a first social graph connecting the user profile to a first set of associated user profiles for the first social network and a second social graph connecting the user profile to a second set of associated user profiles for the second social network;
means for determining a set of user profiles from the first social network and the second social network matching a specified set of search parameters;
means for providing information corresponding to individual user profiles of the set of user profiles, the information provided varying based on a network membership of the individual user profile and a degree of connection between the user profile and the individual profile;
means for providing at least one connection option for connecting with individual user profiles, the at least one connection option being determined based on a network membership of the individual user profile and a connection degree between the user profile and the individual user profile;
means for receiving a selection of a connection option of the at least one connection option; and
executing a process associated with the selected connection option.

30. The apparatus of claim 29, wherein providing at least one connection option comprises determining that the individual user profile is not directly connected to the user profile and that an intermediate user in the first social graph or the second social graph is directly connected to the individual user profile, and wherein the at least one connection option includes requesting the intermediate user to provide an introduction to the individual user profile.

31. The apparatus of claim 29, wherein providing the at least one connection option comprises determining that the individual user profile is directly connected to the user profile though the first social graph and wherein the at least one connection option includes sending a direct message to the individual user profile.

32. The apparatus of claim 29, wherein providing the at least one connection option comprises determining that the individual user profile is a member of the first social network and is not directly connected to the user profile and wherein the at least one connection option includes requesting a direct connection to the individual user profile.

35. The apparatus of claim 29, wherein providing the at least one connection option comprises determining that the individual user profile is not a member of the first social network and wherein the at least one connection option includes sending an invitation to the first social network to the individual user profile.

36. The apparatus of claim 29, wherein the information displayed for the individual user profiles is determined based on privacy settings associated with the first social network or the second social network and wherein the privacy settings allow more information to be displayed when the individual user profile is in the first social network than when the individual user profile is in the second social network.

37. The apparatus of claim 29, wherein the at least one connection option is further determined based on whether a degree of separation between the user profile and the individual user profile is greater than a pre-determined threshold, wherein the pre-determined threshold is greater than two.

38. A computer-implemented method for managing social network interaction for an enterprise, the method comprising:
storing an enterprise profile in a social network for the enterprise;
linking multiple user profiles to the enterprise profile,
wherein the multiple user profiles correspond to multiple individuals associated with the enterprise; and
wherein each user profile includes a social graph connecting the user profile to a set of associated user profiles for the social network;
generating an enterprise social graph based on the linked multiple user profiles, wherein the enterprise social graph includes connections associated with the social graphs for each user profile of the linked multiple user profiles; and
providing the enterprise social graph to an individual associated with the enterprise.

39. The method of claim 39, further comprising retaining connections in the enterprise social graph associated with an individual user profile of the linked multiple user profiles after the individual user profile is no longer linked to the enterprise profile.
